(19) United States
(12) Patent Application Publication
(10) Pub. No.: US 2009/0153067 A1
(43) Pub. Date: Jun. 18, 2009

(54) HIGH FREQUENCY HIGH INTENSITY DISCHARGE BALLAST

(76) Inventor: Louis Robert Nerone, Breckville, OH (US)

Correspondence Address: Fay Sharpe LLP, 1228 Euclid Avenue, 5th Floor, The Halle Building, Cleveland, OH, 44115, US

(21) Appl. No.: 11/955,849

(22) Filed: Dec. 13, 2007

(51) Int. Cl. H05B 37/02

(52) U.S. Cl. 315/209 R

(57) ABSTRACT

A ballast with self-oscillating inverter and a high-voltage multiplier circuit is disclosed for providing a DC start mechanism for starting an HID lamp. The high voltage multiplier ignites the lamp using direct current (DC) voltage. This results in low component stresses and lower output voltages than can be realized either by pulse starting or resonant starting techniques. DC starting reduces an output voltage required to start the HID lamp, and can be applied continuously without damaging the inverter. Moreover, the inverter, in self-oscillating mode, is compact while able to operate the HID lamp at frequencies well in excess of 1 MHz. The self-oscillating inverter can also be employed to regulate lamp power.

### BACKGROUND OF THE INVENTION

The present application is directed to electronic ballasts. It finds particular application in conjunction with high intensity discharge (HID) lamps and the like and will be described with the particular reference thereto. However, it is to be appreciated that the following is also amenable other types of lamps.

A ballast is an electrical device which is used to provide power to a load, such as an electrical lamp, and to regulate the current provided to the load. The ballast provides high voltage to start a lamp by ionizing sufficient plasma (vapor) for the arc to be sustained and to grow. Once the arc is established, the ballast allows the lamp to continue to operate by providing proper controlled current flow to the lamp.

Typically, after the alternating current (AC) voltage from the power source is rectified and appropriately conditioned the inverter converts the DC voltage to AC. The inverter typically includes a pair of serially connected switches, such as MOSFETs which are controlled by the drive gate control circuitry to be “ON” or “OFF.” To correct the above problems, a resonant mode at the frequencies higher than the fundamental frequency might be employed, which requires less current to flow through the inverter components. However, since a square wave is applied to the circuit that resonates at the third harmonic or higher of the fundamental switching frequency, the desired zero switching cannot be achieved. The inverter circuit might also encounter a capacitive mode of operation that would cause damage to the intrinsic diodes of the power MOSFETs. The inverter still cannot be operated continuously without excessive power dissipation in the inverter and must be pulsed “ON” and “OFF” to reduce power dissipation.

The following contemplates new methods and apparatuses that overcome the above referenced problems and others.

### BRIEF DESCRIPTION OF THE INVENTION

According to an aspect, an electronic ballast for igniting and operating a high-intensity discharge (HID) lamp comprises a resonant circuit with a high-frequency bus coupled to the HID lamp and which provides voltage to the HID lamp during operation after ignition, a control circuit, coupled to the high-frequency bus, and a self-oscillating inverter circuit with first and second gate drive circuits that generate a waveform input for the resonant circuit/The ballast further comprises a multiplier circuit that provides an initial DC voltage to ignite the HID lamp.

According to another aspect, an electronic ballast for operating an HID lamp comprises a resonant circuit coupled to the lamp and including a resonant inductance and a resonant capacitance, and a self-oscillating inverter circuit, coupled to the resonant circuit for inducing an AC current in the resonant circuit. The self-oscillating inverter circuit includes first and second switches connected between a bus conductor at a DC voltage and a reference conductor, and connected together at a common node through which the AC load current flows, and gate drive circuitry for controlling the first and second switches. The ballast further includes a clamping circuit, operationally coupled to the resonant circuit and configured to limit a voltage generated by the resonant circuit to a value that does not damage components of the ballast, and a multiplier circuit, connected across terminals of a ballasting capacitor serially coupled to the lamp, the multiplier circuit provides a DC voltage to boost an output voltage of the inverter to a value sufficient to ignite the lamp. The ballast further comprises a control circuit that supplies power to the inverter for a predetermined time each cycle.

According to yet another aspect, a method of igniting and operating an HID lamp comprises providing a voltage from a control circuit to a self-oscillating inverter circuit, generating an initial voltage in the inverter circuit and providing the initial voltage to a resonant circuit coupled to the inverter circuit, passing the initial voltage through terminals of a multiplier circuit, the terminals being connected across a ballasting capacitor serially connect to the HID lamp, and returning a DC boost voltage through the terminals to ignite the HID lamp.

### BRIEF DESCRIPTION OF THE DRAWINGS

FIG. 1 is a diagrammatic illustration of a ballast circuit that includes a plurality of components for using a high-frequency, self oscillating inverter to power a high-intensity discharge (HID) lamp;

FIG. 2 is an illustration of the ballast circuit and a corresponding control circuit coupled thereto, as well as a multiplier circuit coupled to an inverter circuit for igniting the HID lamp;

FIG. 3 is an illustration of a more detailed diagram of the control circuit;

FIG. 4 is an illustration of the multiplier circuit.

### DETAILED DESCRIPTION OF THE INVENTION

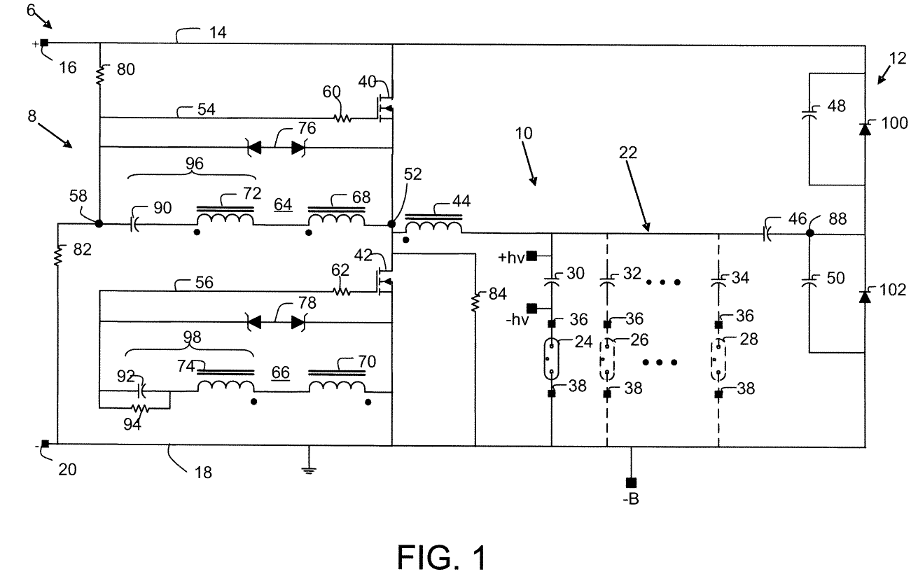

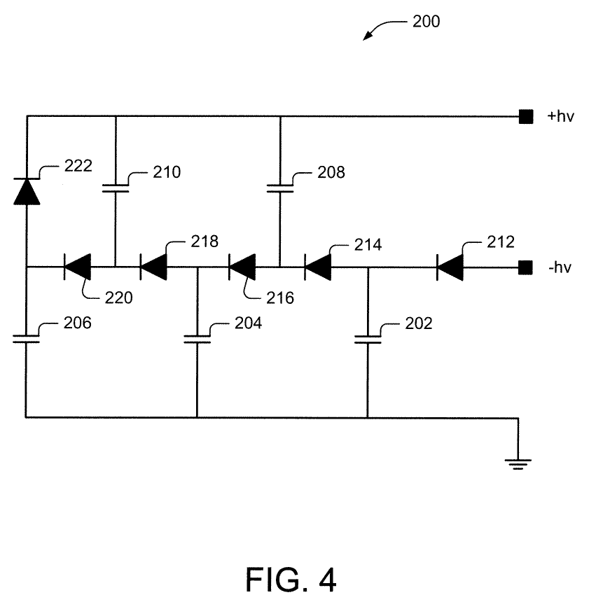

With reference to FIG. 1, a ballast circuit 6 includes a plurality of components that facilitate using a high-frequency, self-oscillating inverter to power a high-intensity discharge (HID) lamp. The ballast circuit includes a self-oscillating inverter 8 that powers a HID lamp in a compact configuration. As opposed to systems that employ pulse start or high-frequency resonant starting, the ballast includes a high voltage multiplier (FIG. 4) that ignites the lamp using direct current (DC) voltage. This in turn results in low component stresses and lower output voltages than can be realized either by pulse starting or resonant starting techniques. That is, DC starting reduces an output voltage required to start the HID lamp, and can be applied continuously without damaging the inverter. Moreover, the inverter, in self-oscillating mode, is compact while able to operate the HID lamp at frequencies well in excess of 1 MHz. This frequency of operation greatly exceeds those that can be achieved by driven inverters (e.g., power-controlled inverter circuits). The self-oscillating inverter can also be employed to regulate lamp power. Additionally, level shifting to the high side switch is not subject to a voltage limitation such as occurs with IC-driven inverters.

The ballast is coupled to one or more HID lamps 24, 26, . . . , 28. In one embodiment, the lamp(s) has a power output of approximately 400 W. The ballast circuit 6 can be employed with a high-voltage multiplier circuit (FIG. 4) to ignite the lamp. It will be appreciated that in an embodiment wherein multiple HID lamps are coupled to the ballast, such as is illustrated, each of the lamps 24, 26, . . . , 28 is coupled to positive and negative high voltage (hv) terminals of a respective multiplier circuit (e.g., each lamp has its own multiplier circuit). In FIG. 1, +hv and −hv terminals are illustrated only for lamp 24, although it is understood that the other lamps have like terminal connections.

The ballast circuit 6 includes the inverter circuit 8, a resonant circuit or network 10, and a clamping circuit 12. A DC voltage is supplied to the inverter 8 via a voltage conductor 14 running from a positive voltage terminal 16 and a common conductor 18 connected to a ground or common terminal 20. A high frequency bus 22 is generated by the resonant circuit 10 as described in more detail below. First, second, . . . , nth lamps 24, 26, . . . , 28 are coupled to the high frequency bus via first, second, . . . , nth ballasting capacitors 30, 32, . . . , 34. Thus if one lamp is removed, the others continue to operate. It is contemplated that any number of lamps can be connected to the high frequency bus 22. E.g., each lamp 24, 26, . . . , 28 is coupled to the high frequency bus 22 via an associated ballasting capacitor 30, 32, . . . , 34. Power to each lamp 24, 26, . . . , 28 is supplied via respective lamp connectors 36, 38.

The inverter 8 includes analogous upper and lower or first and second switches 40 and 42, for example, two n-channel MOSFET devices (as shown), serially connected between conductors 14 and 18, to excite the resonant circuit 10. Two P-channel MOSFETs may also be configured. The high frequency bus 22 is generated by the inverter 8 and the resonant circuit 10 and includes a resonant inductor 44 and an equivalent resonant capacitance which includes the equivalence of first, second and third capacitors 46, 48, 50, and ballasting capacitors 30, 32, . . . , 34 which also prevent DC current flowing through the lamps 24, 26, . . . , 28. The ballasting capacitors 30, 32, . . . , 34 are primarily used as ballasting capacitors.

The switches 40 and 42 cooperate to provide a square wave at a common or first node 52 to excite the resonant circuit 10. Gate or control lines 54 and 56, running from the switches 40 and 42 are connected at a control or second node 58. Each control line 54, 56 includes a respective resistance 60, 62.

With continuing reference to FIG. 1, first and second gate drive circuitry or circuit, generally designated 64, 66, is connected between the nodes 52, 58 and includes first and second driving inductors 68, 70 which are secondary windings mutually coupled to the resonant inductor 44 to induce in the driving inductors 68, 70 voltage proportional to the instantaneous rate of change of current in the resonant circuit 10. First and second secondary inductors 72, 74 are serially connected to the respective first and second driving inductors 68, 70 and the gate control lines 54 and 56.

The gate drive circuitry 64, 66 is used to control the operation of the respective upper and lower switches 40 and 42. More particularly, the gate drive circuitry 64, 66 maintains the upper switch 40 “ON” for a first half of a cycle and the lower switch 42 “ON” for a second half of the cycle. The square wave is generated at the node 52 and is used to excite the resonant circuit 10. First and second bi-directional voltage clamps 76, 78 are connected in parallel to the secondary inductors 72, 74 respectively, each including a pair of back-to-back Zener diodes. The bi-directional voltage clamps 76, 78 act to clamp positive and negative excursions of gate-to-source voltage to respective limits determined by the voltage ratings of the back-to-back Zener diodes. Each bi-directional voltage clamp 76, 78 cooperates with the respective first or second secondary inductor 72, 74 so that the phase angle between the fundamental frequency component of voltage across the resonant circuit 10 and the AC current in the resonant inductor 44 approaches zero during ignition of the lamps.

Serially connected resistors 80, 82 cooperate with a resistor 84, connected between the common node 52 and the common conductor 18, for starting regenerative operation of the gate drive circuits 64, 66. Upper and lower capacitors 90, 92 are connected in series with the respective first and second secondary inductors 72, 74. In the starting process, the capacitor 90 is charged from the voltage terminal 16 via the resistors 80, 82, 84. A resistor 94 shunts the capacitor 92 to prevent the capacitor 92 from charging. This prevents the switches 40 and 42 from turning ON, initially, at the same time. The voltage across the capacitor 90 is initially zero, and, during the starting process, the serially-connected inductors 68 and 72 act essentially as a short circuit, due to a relatively long time constant for charging of the capacitor 90. When the capacitor 90 is charged to the threshold voltage of the gate-to-source voltage of the switch 40, (e.g., 2-3 volts), the switch 40 turns ON, which results in a small bias current flowing through the switch 40. The resulting current biases the switch 40 in a common drain, Class A amplifier configuration. This produces an amplifier of sufficient gain such that the combination of the resonant circuit 10 and the gate control circuit 64 produces a regenerative action which starts the inverter into oscillation, near the resonant frequency of the network including the capacitor 90 and inductor 72. The generated frequency is above the resonant frequency of the resonant circuit 10, which allows the inverter 8 to operative above the resonant frequency of the resonant network 10. This produces a resonant current which lags the fundamental of the voltage produced at the common node 52, allowing the inverter 8 to operate in the soft-switching mode prior to igniting the lamps. Thus, the inverter 8 starts operating in the linear mode and transitions into the switching Class D mode. Then, as the current builds up through the resonant circuit 10, the voltage of the high frequency bus 22 increases to ignite the lamps, while maintaining the soft-switching mode, through ignition and into the conducting, arc mode of the lamps.

During steady state operation of the ballast circuit 6, the voltage at the common node 52, being a square wave, is approximately one-half of the voltage of the positive terminal 16. The bias voltage that once existed on the capacitor 90 diminishes. The frequency of operation is such that a first network 96 including the capacitor 90 and inductor 72 and a second network 98 including the capacitor 92 and inductor 74 are equivalently inductive. That is, the frequency of operation is above the resonant frequency of the identical first and second networks 96, 98. This results in the proper phase shift of the gate circuit to allow the current flowing through the inductor 44 to lag the fundamental frequency of the voltage produced at the common node 52. Thus, soft-switching of the inverter 8 is maintained during the steady-state operation.

With continuing reference to FIG. 1, the output voltage of the inverter 8 is clamped by serially connected clamping diodes 100, 102 of the clamping circuit 12 to limit high voltage generated to start the lamps 24, 26, . . . , 28. The clamping circuit 12 further includes the second and third capacitors 48, 50, which are essentially connected in parallel to each other. Each clamping diode 100, 102 is connected across an associated second or third capacitor 48, 50. Prior to the lamps starting, the lamps' circuits are open, since impedance of each lamp 24, 26, . . . , 28 is seen as very high impedance. The resonant circuit 10 is composed of the capacitors 30, 32, . . . , 34, 46, 48, 50 and the resonant inductor 44 and is driven near resonance. As the output voltage at the common node 52 increases, the clamping diodes 100, 102 start to clamp, preventing the voltage across the second and third capacitors 48, 50 from changing sign and limiting the output voltage to the value that does not cause overheating of the inverter 8 components. When the clamping diodes 100, 102 are clamping the second and third capacitors 48, 50, the resonant circuit 10 becomes composed of the capacitors 30, 32, . . . , 34, 46 and the resonant inductor 44. E.g., the resonance is achieved when the clamping diodes 100, 102 are not conducting. When the lamps ignite, the impedance decreases quickly. The voltage at the common node 52 decreases accordingly. The clamping diodes 100, 102 discontinue clamping the second and third capacitors 48, 50 and the ballast 6 enters steady state operation. The resonance is dictated again by the capacitors 30, 32, . . . , 34, 46, 48, 50 and the resonant inductor 44.

In the manner described above, the inverter 8 provides a high frequency bus at the common node 52 while maintaining the soft switching condition for switches 40, 42. The inverter 8 is able start a single lamp when the rest of the lamps are lit because there is sufficient voltage at the high frequency bus to allow for ignition. Additionally or alternatively the multiplier circuit ensures that sufficient power is available for lamp ignition.

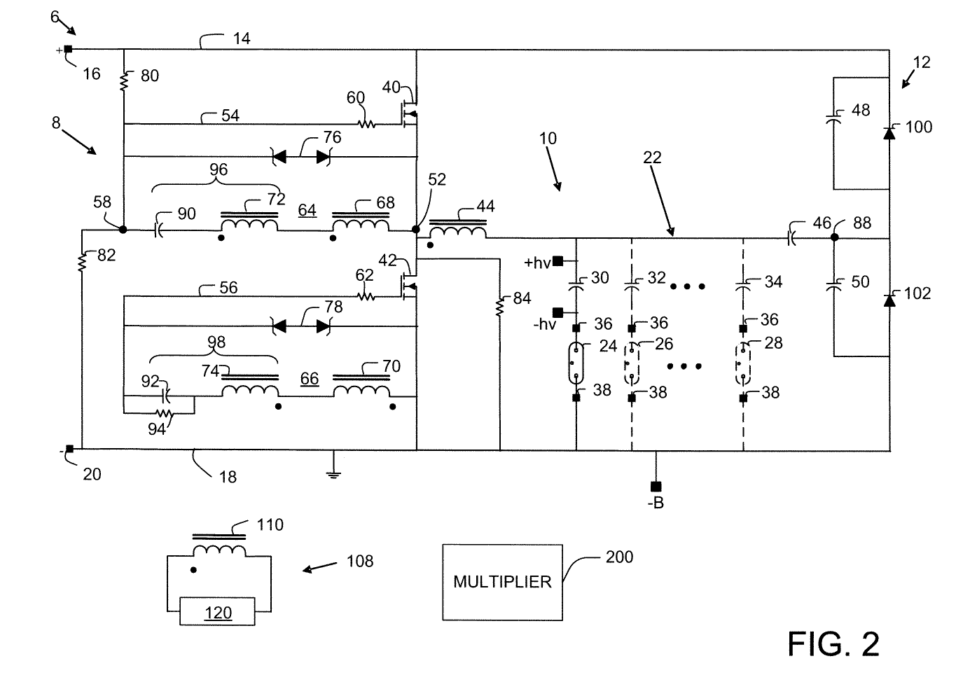

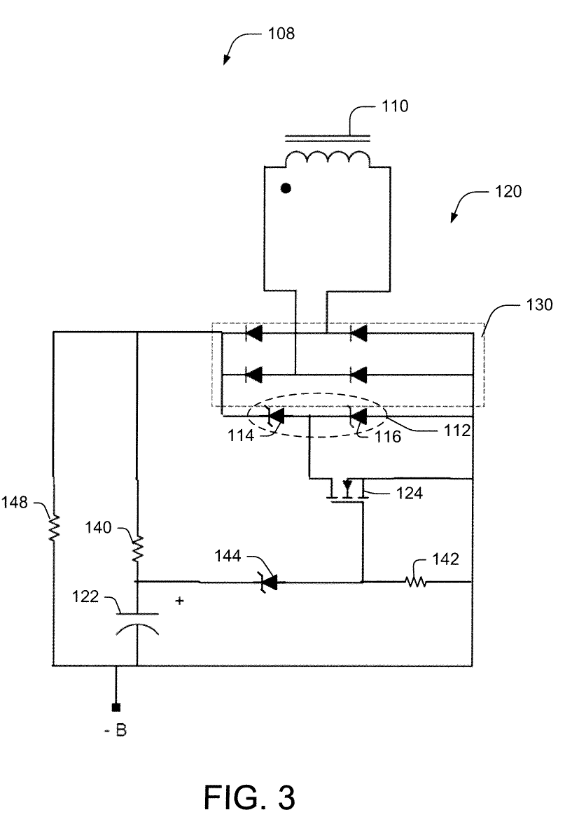

With reference to FIGS. 2 and 3, a tertiary circuit 108 is coupled to the inverter circuit 8. More specifically, a tertiary winding or inductor 110 is mutually coupled to the first and second secondary inductors 72, 74 and first and second Zener diode clamps 76, 78. The resonant circuit 10 also includes a node-B, which may be considered a ground. An auxiliary or third voltage clamp 112, which includes first and second Zener diodes 114, 116, is connected in parallel to the tertiary inductor 110. Because the tertiary inductor 110 is mutually coupled to the first and second secondary inductors 72, 74, the auxiliary voltage clamp 112 simultaneously clamps the first and second gate circuits 64, 66.

More specifically, prior to ignition, a capacitor 122 is discharged, causing a switch 124, such as a MOSFET, to be in the “OFF” state. When the inverter 8 starts to oscillate, the capacitor 122 charges via lines 126 and 128. The tertiary winding 110 is clamped by parallel-connected first and second Zener diodes 114, 116 that are coupled to the drain and source of the MOSFET 124. When a high-power start mode is employed in the controller 120, a high-frequency of the input signal causes the capacitor 122 to charge, which causes Zener diode 116 to turn on, which in turn causes MOSFET 124 to turn ON and the control circuit to start regulating. That is, once the capacitor 122 charges to a predefined voltage, such as the threshold voltage of the MOSFET 124, the MOSFET 124 turns ON and current is shunted away from the second Zener diode 116 that is connected to the source terminal of the MOSFET 124. The capacitor 122 is connected to a resistor 140 that is coupled to the cathode of diode 114, and a resistor 142 is connected to the gate and drain of the MOSFET 124. The resistor 142 is also coupled to the anode of the Zener diode 116. The circuit 108 further includes a Zener diode 144, the anode of which is connected to the gate of the MOSFET 124 and the resistor 142, and the cathode of which is coupled to the capacitor 122 and the resistor 140. A resistor 148 is coupled in parallel with resistor 140 and coupled to the cathode of Zener diode 114.

FIG. 4 is an illustration of a multiplier circuit 200 that boosts the voltage limited by the clamping circuit 16. The multiplier 200 is connected across capacitor 30 to achieve a starting voltage by multiplying inverter 12 output voltage. At the beginning of the operation, inverter 12 supplies voltage to the multiplier circuit via terminals +hv, −hv. Capacitors 202, 204, 206, 208, 210 cooperate with diodes 212, 214, 216, 218, 220, 222 to accumulate charge one half of a cycle, while during the other half of the cycle the negative charge is dumped into capacitor 30 through terminal +hv. Typically, when inverter 12 voltage is 500V peak to peak, the voltage across terminals +hv, −hv rises to about −2 kVDC.

In one embodiment, the multiplier 200 is a low DC bias charge pump multiplier. During steady-state operation the multiplier 200 applies only a small dc bias (about 0.25 Volts) to the lamp which does not affect the lamp's operation or life.

It is to be appreciated that the foregoing example(s) is/are provided for illustrative purposes and that the subject innovation is not limited to the specific values or ranges of values presented therein. Rather, the subject innovation may employ or otherwise comprise any suitable values or ranges of values, as will be appreciated by those of skill in the art.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An electronic ballast for igniting and operating a high-intensity discharge (HID) lamp, comprising:
a resonant circuit with a high-frequency bus coupled to the HID lamp and which provides voltage to the HID lamp during operation after ignition;
a control circuit, coupled to the high-frequency bus;
a self-oscillating inverter circuit with first and second gate drive circuits that generate a waveform input for the resonant circuit;
a multiplier circuit that provides an initial DC voltage to ignite the HID lamp.

2. The ballast according to claim 1, further comprising a plurality of HID lamps, each coupled to a corresponding multiplier circuit.

3. The ballast according to claim 1, wherein the multiplier circuit precludes forward biasing of diodes to reduce power dissipation.

4. The ballast according to claim 1, wherein the multiplier circuit precludes forward biasing of diodes realizing a DC bias of approximately +/−0.25V or less.

5. The ballast according to claim 1, further including: a ballasting capacitor operationally connected in series with the HID lamp and between a positive terminal (+hv) and a negative terminal (−hv) of the multiplier circuit.

6. The ballast according to claim 5, wherein the multiplier circuit is operationally connected to the terminals to multiply an output voltage of the inverter through the terminals and store negative charge into the ballasting capacitor through terminals.

7. The ballast according to claim 1, wherein the self-oscillating inverter operates the HID lamp at a frequency of approximately 900 KHz or greater.

8. The ballast according to claim 1, wherein the HID lamp has a power rating of at least approximately 300 W.

9. An electronic ballast for operating an HID lamp, comprising:
a resonant circuit coupled to the HID lamp and including a resonant inductance and a resonant capacitance;
a self-oscillating inverter circuit, coupled to the resonant circuit for inducing an AC current in the resonant circuit, the inverter circuit including:
first and second switches connected between a bus conductor at a DC voltage and a reference conductor, and connected together at a common node through which the AC load current flows; and
gate drive circuitry for controlling the first and second switches;
a clamping circuit, operationally coupled to the resonant circuit and configured to limit a voltage generated by the resonant circuit to a value that does not damage components of the ballast;
a multiplier circuit, connected across terminals of a ballasting capacitor serially coupled to the HID lamp, the multiplier circuit provides a DC voltage to boost an output voltage of the inverter to a value sufficient to ignite the HID lamp; and
a control circuit that supplies power to the inverter for a predetermined time each cycle.

10. The ballast according to claim 9, wherein the clamping circuit includes a pair of serially connected diodes, each diode connected across an associated capacitor.

11. The ballast according to claim 9, wherein the multiplier circuit includes: capacitors and diodes that cooperate to preclude forward biasing of diodes to reduce power dissipation in the ballast.

12. The ballast according to claim 11, wherein the multiplier circuit cooperates with the inverter to accumulate charge in the capacitors for a first half of a cycle and dump the accumulated charge into the ballasting capacitor for a second half of the cycle.

13. The ballast according to claim 11, wherein the multiplier circuit precludes forward biasing of diodes realizing a DC bias of approximately +/−0.25V or less.

14. The ballast according to claim 9, wherein the inverter operates the HID lamp at a frequency of approximately 900 KHz or greater.

15. The ballast according to claim 9, wherein the HID lamp has a power rating of at least approximately 300 W.

16. A method of igniting and operating an HID lamp, comprising:
providing a voltage from a control circuit to a self-oscillating inverter circuit;
generating an initial voltage in the inverter circuit and providing the initial voltage to a resonant circuit coupled to the inverter circuit;
passing the initial voltage through terminals of a multiplier circuit, the terminals being connected across a ballasting capacitor serially connect to the HID lamp; and
returning a DC boost voltage through the terminals to ignite the HID lamp.

17. The method according to claim 16, further comprising accumulating charge in capacitors in the multiplier circuit for a first half of a cycle and dumping the accumulated charge into the ballasting capacitor for a second half of the cycle.

18. The method according to claim 16, wherein the multiplier circuit precludes forward biasing of diodes realizing a DC bias of approximately +/−0.25V or less.

19. The method according to claim 16, wherein the inverter circuit operates the HID lamp at a frequency of approximately 900 KHz or greater.

20. The method according to claim 16, wherein the HID lamp has a power rating of at least approximately 300 W.
